(19) United States
(12) Patent Application Publication
(10) Pub. No.: US 2009/0095804 A1
(43) Pub. Date: Apr. 16, 2009

(54) RFID FOR CONNECTED ACCESSORY IDENTIFICATION AND METHOD

(75) Inventors: Markus AGEVIK, Malmo (SE); David JOHANSSON, Malmo (SE); Anders LUNDQUIST, Malmo (SE); Anders HANSSON, Klagerup (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/872,244

(22) Filed: Oct. 15, 2007

Related U.S. Application Data
(60) Provisional application No. 60/979,560, filed on Oct. 12, 2007.

(51) Int. Cl. G06K 7/10

(52) U.S. Cl. 235/375

(57) ABSTRACT

A connector system, includes a first connector having a number of connection paths adapted to connect with a second connector, and an RFID reader adapted to receive information identifying at least one characteristic of such second connector. The connector system may be used in portable electronic equipment that includes operating circuitry, a display, an input apparatus, a connector adapted for connection to an accessory, and the an RFID reader adapted to receive information identifying at least one characteristic of an accessory and/or of an accessory connector, and wherein said operating circuitry is responsive to such identification or lack of such identification to determine settings for the portable electronic equipment. A method of identifying an accessory to electronic equipment uses RFID communication between such accessory and such electronic equipment to identify such accessory to such electronic equipment.

### CROSS-REFERENCE TO RELATED APPLICATION

This application claims the benefit of U.S. Provisional Patent Application Ser. No. 60/979,560, filed Oct. 12, 2007, the entire disclosure of which is hereby incorporated by reference.

### TECHNICAL FIELD

The present invention relates generally to electronic equipment and use of RFID to identify accessories or characteristics of accessories connected to the electronic equipment and method, and, more particularly, to portable electronic equipment and method using RFID features to identify connectors or electronic equipment connected to such portable electronic equipment.

### BACKGROUND

Mobile and/or wireless electronic devices are becoming increasingly popular. For example, mobile telephones, portable media players and portable gaming devices are now in wide-spread use. In addition, the features and accessories associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces. Exemplary accessories may also include headphones, music and video input players, etc.

Many mobile and/or wireless electronic devices include audio connectors to which accessories, such as, for example, handsfree headsets, headphones, etc. may be connected. Sometimes an electric circuit established by the audio connector of the electronic device and an accessory connector of the accessory identifies the accessory or identifies the accessory connector thereby identifying the accessory and, thus, may indicate to operating circuitry of the electronic device the manner in which other signals provided between the electronic device and the accessory are to be used, treated, addressed, etc. For example, different accessories may require different input signals from the electronic device at respective EQ level, bandwidth, amplitude, etc. Similarly, settings of operating circuitry of the electronic device may have to consider different characteristics of input signals received from the accessory.

Some new connectors do not include a circuit for identifying the accessory or accessory connector, and this may present a problem in either not being able to identify and/or to recognize an accessory or the like. Not identifying or recognizing an accessory may lead to either not being able to take best advantage of the accessory and/or cooperation between the accessory and electronic device or possibly not being able to use the accessory with the electronic device.

As an example, some audio connectors of portable electronic devices have used five pins or five electrical paths for connection with corresponding pins or electrical paths of the accessory connector of an accessory, and one of those pins/electrical paths may be used for accessory identification. However, in the interest of reducing size of portable electronic devices an audio connector may have only four pins or electrical paths that may not provide for identifying the accessory. One such electrical connector is referred to as a 3.5 millimeter connector.

### SUMMARY

Briefly, in accordance with one aspect of the present invention RFID is used to identify an accessory connected to an electronic device, such as, for example, a portable electronic device.

An aspect of the invention relates to use of an RFID tag to identify at least one characteristic of an accessory or a connector of the accessory or to identify the connector itself that is connected to an electronic device, e.g., a mobile phone.

Another aspect relates to a connector system, including a first connector having a number of connection paths adapted to connect with a second connector, and an RFID reader adapted to receive information identifying at least one characteristic of such second connector.

Another aspect relates to such connector system and further comprising the second connector and an RFID tag identifying at least one characteristic of said second connector.

Another aspect relates to such connector system and further comprising an electronic device with operating circuitry, said first connector being operatively coupled with said operating circuitry, and wherein said RFID reader is operatively coupled with said operating circuitry to indicate the identified at least one characteristic from said RFID tag of said second connector.

Another aspect relates to such connector system wherein the connection paths are electrical connection paths adapted to transmit electrical signals and/or to provide for electrical power connection.

Another aspect relates to such connector system wherein the connection paths are optical adapted to transmit optical signals.

Another aspect relates to such connector system, further comprising an electronic device with operating circuitry, said first connector being operatively coupled with said operating circuitry, and wherein said RFID reader is operatively coupled with said operating circuitry to indicate an identified at least one characteristic from an RFID tag of such second connector.

Another aspect relates to such connector system, wherein the electronic device comprises portable electronic equipment, said first connector comprises a connector adapted to connect respective second connectors of accessories for use with said portable electronic equipment.

Another aspect relates to such connector system, wherein said operating circuitry is adapted to adjust settings according to an identified at least one characteristic as a representation of an accessory to which such second connector is associated.

Another aspect relates to such connector system, wherein said operating circuitry is adapted to respond to information identifying at least one characteristic of a second connector received by said RFID reader to determine functioning of said operating circuitry in respect to signals received by said first connector and/or to such respective accessory.

Another aspect relates to such connector system, wherein said operating circuitry is adapted to assume a default setting if said RFID reader has not received information identifying at least one characteristic of such second connector.

Another aspect relates to such connector system, wherein said portable electronic equipment comprises a mobile telephone.

Another aspect relates to such connector system, wherein said RFID tag is a passive transponder adapted to provide a response to said RFID reader.

Another aspect relates to such connector system, wherein said RFID tag is an active transponder responsive to input from said RFID reader.

Another aspect relates to such connector system, wherein said RFID reader is a near field communication device adapted to cooperate in RFID relation with an RFID transponder in near field relation to said RFID reader.

Another aspect relates a method of identifying an accessory to electronic equipment including using RFID communication between such accessory and such electronic equipment to identify such accessory to such electronic equipment.

Another aspect relates to such method, wherein said using RFID communication comprises using near field communication between an RFID reader and an RFID transponder.

Another aspect relates to such method, further comprising determining settings in operating circuitry of such electronic equipment based on identification of such accessory.

Another aspect relates to such method wherein said determining settings comprises establishing or maintaining default setting in the absence of a recognized RFID response from an RFID transponder.

Another aspect relates to portable electronic equipment, including operating circuitry, a display, an input apparatus, a connector adapted for connection to an accessory, and an RFID reader adapted to receive information identifying at least one characteristic of an accessory and/or of an accessory connector, and wherein said operating circuitry is responsive to such identification or lack of such identification to determine settings for the portable electronic equipment.

Another aspect relates to such portable electronic equipment comprising a mobile telephone, and said input apparatus comprises a keypad.

Another aspect relates to such portable electronic equipment, further comprising an accessory including an accessory connector connectible with said connector, and an RFID tag cooperable with said RFID reader to provide such identifying information.

Another aspect relates to such portable electronic equipment, wherein said RFID tag is an active transponder responsive to input from said RFID reader.

Another aspect relates to such portable electronic equipment wherein said RFID tag is a passive transponder adapted to provide a response to said RFID reader.

Another aspect relates to such portable electronic equipment, wherein said RFID reader is a near field communication device adapted to cooperate in RFID relation with said RFID transponder in near field relation to said RFID reader.

Another aspect relates to such portable electronic equipment, wherein said operating circuitry is adapted to assume default setting in the absence of a recognizable or recognized RFID response from an RFID tag.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

In the annexed drawings:

FIG. 1 is a schematic illustration of the front of a portable communication device, e.g., in the form of a mobile phone;

FIG. 2 is a schematic block system diagram of circuitry of the mobile phone for carrying out operation thereof in a manner described below; and

FIG. 3 is a schematic flow chart illustrating exemplary logic according to which the invention may operate.

### DESCRIPTION

The interchangeable terms “electronic equipment” and “electronic device” include portable radio communication equipment. The term “portable radio communication equipment,” which hereinafter is referred to as a “mobile radio terminal,” as “portable electronic equipment,” or as a “portable communication device,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device, PDA and a computer, etc.

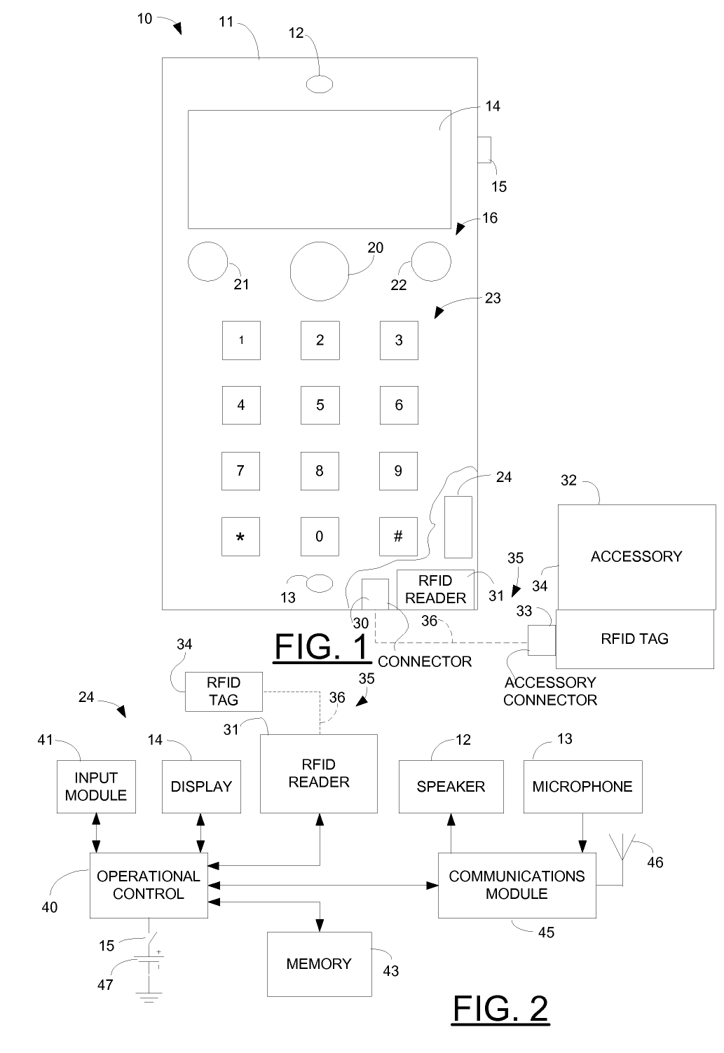

Referring in detail to the drawings, and initially to FIG. 1, a portable communication device in accordance with an embodiment of the present invention is illustrated generally at 10. The portable communication device 10 will be referred to below as a mobile phone. However, as was mentioned above, reference to “mobile phone” includes various other devices, such as, for example, those mentioned above. In outward appearance, for example, as is illustrated in FIG. 1, the mobile phone is of one type of design or style; however, the features of the invention, as are described in further detail below, may be used in other types of mobile phones, such as those that include cases that open and close (sometimes referred to as a “flip phone”), and various other mobile phones that currently exist or may come into existence in the future.

The mobile phone 10 includes case (housing) 11, speaker 12, microphone 13, display 14, e.g., liquid crystal display, light emitting diode display, or other display, on/off switch 15, and a number of keys generally indicated at 16. The keys 16 may include a number of keys having different respective functions. For example, the key 20 may be a navigation key, selection key or some other type of key; the keys 21, 22 may be, for example, one or more soft switches or soft keys; and the keys 23 may be dialing keys. As an example, the navigation key may be used to scroll through lists shown on the display 14, to select one or more items shown in a list on the display 14, etc. The soft switches 21, 22 may be manually operated to carry out respective functions, such as those shown or listed on the display 14 in proximity to the respective soft switch or selected by the navigation key 20, etc. The soft keys 21, 22 may be used to initiate a phone call, e.g., to connect to a wireless telephone circuit and to transmit a telephone number, etc., to answer an incoming phone call, to transmit a text message, etc., to end a phone call, and/or to carry out other functions.

The dialing keys 23 may be used to dial a telephone number or to input alphanumeric or other data. The speaker 12, microphone 13, display 14, and keys 16 may be used and function in the usual ways in which a mobile phone typically is used, e.g. to initiate, to receive and/or to answer telephone calls, to send and to receive text messages, to connect with and carry out various functions via a network, such as the Internet or some other network, to beam information between mobile phones, etc. These are examples; there may be other uses that currently exist or may exist in the future. The mobile phone 10 also includes operating circuitry 24 that responds to programming and to inputs, e.g., provided by a user pressing a key or applying a stylus or finger to a touch-sensitive screen, etc. or provided from an external source, such as an incoming telephone call or text message, to carry out functions of the mobile phone.

As is described in further detail below, an RFID tag may be used to identify at least one characteristic of an accessory or a connector of the accessory or to identify the connector itself that is connected to the mobile phone 10. Using RFID methods to provide such identity such identification may be achieved without the need for a separate connection path in the connector 30 and an accessory connector. The term “RFID” is a shorthand reference to radio frequency identification. RFID devices are commercially available and may include RFID readers and RFID tags or transponders. Various types of RFID devices that currently are available and those that may become available in the future may be used in accordance with the present invention.

The mobile phone 10 includes a connector 30 (sometimes referred to as a first connector) and an RFID reader 31. In FIG. 1 part of the housing 11 is broken away to show exemplary locations and relative positioning of the connector 30 and RFID reader 31 within the housing. The RFID reader is coupled to the operating circuitry 24. The RFID reader 31 may be a conventional RFID reader that provides a signal to an RFID tag (sometimes referred to as an RFID transponder) to attempt to obtain from the RFID tag a response that can be read by the RFID reader and/or understood. The connector 30 may be, for example, an audio connector (sometimes referred to as an audio jack), to which various accessories may be connected via a respective accessory connector. An exemplary accessory 32 is illustrated in FIG. 1. The accessory 32 has an accessory connector 33 (sometimes referred to as a second connector) and an RFID tag 34 that is on or in the accessory connector or accessory. The position of the RFID tag is such that when the accessory connector 33 is connected to the connector 30, e.g., by plugging the accessory connector 33 into the connector 30, the RFID tag and the RFID reader 31 are in close proximity such that the RFID reader can provide a signal to the RFID tag and receive a response from the RFID tag without having to in a sense pollute the local area with radio frequency signals that might otherwise interfere with operation of the mobile phone 10 or other equipment in the vicinity of the mobile phone. The term near field sometimes is used to indicate the close proximity relation of the RFID reader and RFID tag to obtain such operation.

The RFID reader is coupled to the operating circuitry 24 so as to provide to the operating circuitry signals, information, etc., indicating the identity of the accessory 32 or of the accessory connector 33 or information identifying at least one characteristic of the accessory connector and/or accessory. Based on such identity information the operating circuitry may determine or adjust settings for use with such accessory or accessory connector. Examples of such determined settings may include pin-outs, e.g., what signals are provided to or are expected to be provided to respective circuits coupled by the two connectors, amplification settings of amplifiers in the operating circuitry and/or in the accessory, EQ settings, bandwidth, etc. The operating circuitry 24 also may include capability to assume a default setting or condition in the event a suitable RFID signal is not received, e.g., is lacking, for example, either if no signal is received from an RFID tag, e.g., in the case that there is no RFID tag associated with the accessory or accessory connector, or if the signal and/or identity information received from an RFID tag is not recognized by the RFID reader and/or by the operating circuitry. Thus, the identifying information provided the operating circuitry 24 via RFID techniques may determine functioning of the operating circuitry.

Exemplary accessories may be headsets, mono or stereo headphones, external amplifier(s) and/or speaker(s), etc. Other types of accessories may be used with the connector 30 and mobile phone 10 to receive outputs from the connector and/or to provide inputs to the connector. Exemplary accessories may be used for telephone communications, for listening to music, for listening to the soundtrack of a movie being viewed on the display of the mobile phone, etc.

Many types of RFID systems 35, including RFID readers 31 and RFID tags 34 currently exist and may be used in the invention. The RFID system 35, including the RFID reader 31 and the RFID tag 34, may be of the passive RFID type using a passive RFID tag 34 (sometimes referred to as a passive transponder), or an active RFID type using an active RFID tag 34 (sometimes referred to as an active transponder). In a passive RFID tag there usually is no separate power source; in an active RFID tag there may be a power source. The invention may use various RFID systems 35 that currently exist and those that may come into existence in the future.

The RFID tag 34 may be in the accessory connector 33, provided there is adequate space therefor. By including the RFID tag 34 in the accessory connector 33 the distance between the RFID tag 34 and the RFID reader 32 may be relatively minimized provide several possible advantages, including, for example, minimizing size requirements, signal strength requirements, and possible interference with other signals.

The connector 30 and accessory connector 32 may be various types of connectors. One example of such connectors are those used to provide audio signals and sometimes are referred to as audio jacks or audio connectors. Other types of connectors for audio and/or for other purposes also may be used in accordance with the invention. The connection paths represented by dotted line 36 in FIG. 1 between the connector 30 and accessory connector 33 may be respective electrically conductive paths including wires, terminals, contacts, signal traces on a substrate, etc.; and such electrically conductive paths connect and conduct electrical signals and/or power. In another embodiment the connection paths may be optical to connect optical signals between the connector 30 and accessory connector 33 and/or with other parts, e.g., to the accessory 32 and/or to the operating circuitry 24, etc. Suitable electrical-optical signal conversion circuitry may be included, as necessary, for use with an optical connection embodiment.

In using the invention, an accessory is identified to electronic equipment by using RFID communication between an RFID reader and an RFID transponder or RFID tag associated with the accessory. Near field communication may be used between the RFID reader and the RFID tag, as was described above. Based on the identification of the accessory operating circuitry of the electronic equipment may be determined; if identification is not made or if there is no RFID tag signal received or if a received signal is not recognized, the operating circuitry may assume a default condition or setting.

Thus, it will be appreciated that if the number of pins, connection paths, etc. of a connector is reduced such that there is no convenient ability to identify an accessory or an accessory connector, for example, the RFID system in combination with a connector and the associated method used in the present invention may provide for such identification. Such identification allows for or facilitates adjusting settings of the electronic device, e.g., the operating circuitry 24 of the mobile phone 10, according to the accessory or according to the accessory connector.

Summarizing the above, then, an RFID reader 31 may be placed in the mobile phone 10 near the audio connector 30, for example. On the accessory connector 33 there is a RFID tag 34 that identifies what kind of accessory 32 that is put in or attached to the mobile phone, e.g., the accessory connector 33 may be inserted into the audio connector 30 or may be otherwise attached to a connector of the mobile phone 10. When the mobile phone detects an accessory connector it tries to read out the RFID tag. Since the RFID reader is tuned for short range it will read the accessory identification (accID) from the RFID tag. If an unknown accessory is put in (inserted) or otherwise is attached to the connector 30 the standard or default settings are applied, e.g., by the operating circuitry 24. The unknown accessory may be one that is a different brand than the mobile phone 10, one that is incompatible with the mobile phone or with the connector 30 or operating circuitry 24 thereof, etc.

In using the invention the combination of reading a connector with too few pins to have a identifier and an RFID tag in a mobile phone accessory allows effective and efficient use of the mobile phone and the accessory. It is possible to have a wide range of identification for accessories in platforms not supporting enough pins in the connector for identification. For example, using the invention to identify accessories, proper and/or effective adjustments can be made, e.g., by the operating circuitry 24 or by other parts of the mobile phone and/or accessory, e.g., for EQ and audio level, for example, to meet various requirements and to provide good control and audio performance with the identified accessories.

Turning to FIG. 2, a schematic block system diagram of operating circuitry 24 of the mobile phone 10 is illustrated. The illustration is exemplary; other types of circuitry may be employed in addition to or instead of the operating circuitry 24 to carry out the various functions of a mobile phone and the various functions described in detail herein. The operating circuitry includes an operational control 40 that controls the various components of the operating circuitry 24. An input module 41 provides inputs to the operational control 40, such as, for example, inputs from the various keys 16. Inputs also may be provided from the display 14 if it is a touch screen type of display, and inputs also may be provided the input module 41 from other connections to the mobile phone, etc. The display 14 may be a touch screen that provides for inputs to the input module 41 by touching using a finger, a stylus, or some other device, and the result of such touching may be provided as inputs to the operational control 40. The operational control 40 also may operate the display 14 to determine what information, icons, images, etc. is shown on the display 14.

The RFID reader 31 is coupled to and operates in response to the operational control 40 and/or in response to receiving a suitable input from an RFID tag 34. Electrical power is provided by the operational control 40 to the RFID reader 31. Program code in the operating circuitry 24, e.g., stored in the memory 43, may control operation of the operational control 40 to energize the RFID reader, if necessary, and to read any return signal from an RFID tag 31. Circuitry in and/or programming in the operating circuitry and/or operational control 40 may determine whether a returned RFID signal from the RFID tag 34 is recognized and what is the identity information being conveyed by it. According to a recognized identity, then, the operating circuitry 24 may determine settings for proper use with the accessory 32.

As an example, the operational control 40 may be a microprocessor or some other electrical or electronic device that is responsive to various inputs, e.g., input signals, and provides various outputs, e.g., output signals. The operational control 40 may be internally programmed or manufactured in a way to include internal programming thereof to carry out various functions. However, in many instances an operational control 40 of a mobile phone 10 would have associated therewith the memory 43 in which appropriate programming instructions, computer program, logic, etc., may be provided the operational control 40 to carry out the functions thereof. The memory 43 may include identity information concerning respective accessories and settings of the operating circuitry in response to respective identity information. The memory 43 also may include storage for telephone numbers and other information concerning contacts who may be called, messaged, etc. using the mobile phone 10, storage of photographs and/or other data, as often is the capability of such memory in conventional mobile phones, for example, and the memory may be used for other purposes that may come into existence in the future. The memory 43 may be a read only memory, random access memory (RAM), flash RAM, programmable read only memory, or some other memory device. Also associated with the operational control 40 is a timer 44 that can be used to provide timing signals representing increments of time for synchronizing operation of the operating circuitry 24 with some other device, for clock/calendar control functions, and/or for determining amount of time (duration) for a screensaver function.

The operating circuitry 24 also includes a communications module 45 that receives inputs from microphone 13 and provides outputs to the speaker 12, as are common functions in a mobile phone. An antenna 46 may be coupled to the communications module 45 to transmit and to receive signals representing telephone communications, data communications, messages, etc. The communications module 45 may operate under control of the operational control 40 in the usual manner of a mobile phone. Additionally, the communications module 45 may provide an input to the operational control 40 to indicate that there is an incoming telephone call or text message; and in response thereto, the operational control 40 may operate the display 14 in conventional manner, e.g., to indicate an incoming phone call, to show a text message or photograph, etc.

A power supply 47 provides electrical power to the operating circuitry 24 and/or to other parts of the mobile phone 10 via the on/off switch 15. The power supply may be a conventional battery or some other source of electrical power. Upon closing the on/off switch 15, the power is provided the operating circuitry 24 to carry out the various functions described herein, for example. If desired, closing the switch 15 may lead to temporary operation of the display to display a start-up message or indication, and then a power saving feature, e.g., a screensaver function, may be implemented to turn off the display.

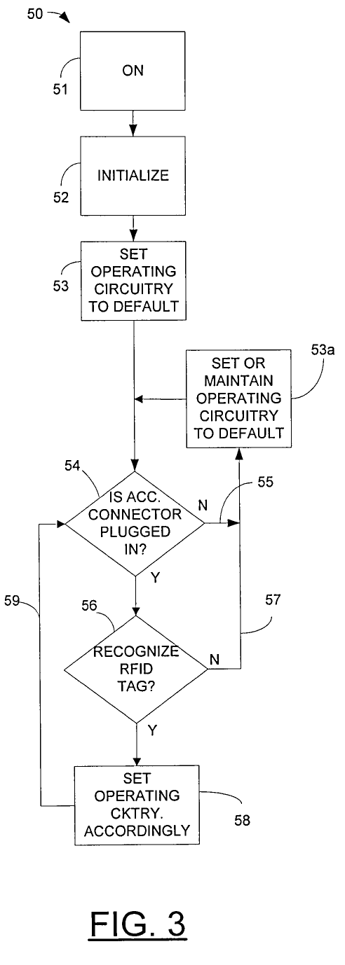

A computer program flow chart or logic diagram is illustrated at 50 in FIG. 3. Such flow chart 50 represents functions that may be carried out in the operating circuitry 24 in carrying out an embodiment of the invention as an example. The functions illustrated in FIG. 3 and described herein with regard to respective “blocks” that may represent steps in a computer program or a method, for example, may be provided the operating circuitry as a computer program, for example, that is written in appropriate computer language or logic format to carry out the various steps described. A person having ordinary skill in the art would be able to write such program to carry out the steps and functions illustrated and described here. It will be appreciated that the program code may be stored in a storage medium. For example, as is described, the program code may include a computer program that recognizes an RFID signal received by the RFID reader 31 and to provide in response thereto a representation of the identity of an accessory or of an accessory connector.

Initially the portable electronic equipment, e.g., mobile phone 10, is turned on at block 51, for example, by closing the on-off switch or power switch 15, and the mobile phone, including the operating circuitry 24 is initialized at block 52. Initialization functions are carried out in many types of electronic equipment and will depend on the various functions, capabilities, etc. of the equipment, as is known. At block 53 the operating circuitry is set to default condition for normal operation of the mobile phone 10, e.g., as it would operate absent an accessory connected thereto. At block 54 an inquiry is made whether an accessory connector 33 is connected to the connector 30. If no, then loop 55 is followed and at block 53a the operating circuitry 24 either is set or is maintained in default mode, as is mentioned above, e.g., with no adjustments for accessory attachment. For example, if the operating circuitry 24 had not been changed from default mode to some other mode based on the attached accessory 32, then at block 53a default mode is maintained, but if there had been a change, then following of loop 55 to block 53a would lead to a setting of the operating circuitry to default mode. If the accessory connector 33 had been plugged into or attached to the connector 30 and then is removed or disconnected from the connector 30, the loop 55 and block 55 will assure that the operating circuitry would be set or maintained in default mode.

If at inquiry block or step 54 the answer to the inquiry is yes, then at block 56 an inquiry is made whether an acceptable RFID tag is recognized, e.g., is one that provides identity information pertaining to an acceptable accessory 32 or connector 33 that can be used with the mobile phone 10. If no, then loop 57 and 55 is followed; if yes, then at block 58 the operating circuitry 24 is set according to such identity information. The routine then returns via loop 59 to block 54 and repeats as just described.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A connector system, comprising:
a first connector having a number of connection paths adapted to connect with a second connector that is associated with an accessory,
an electronic device with operating circuitry, said first connector being operatively coupled with said operating circuitry, and
an RFID reader adapted to receive information identifying at least one characteristic of such second connector, the RFID reader being operatively coupled with said operating circuitry to provide the operating circuitry with the received information,
wherein the operating circuitry is adapted to adjust settings of the operating circuitry and/or the electronic device in response to information identifying at least one characteristic of the second connector, and wherein the settings determine functioning of the operating circuitry and/or the electronic device with respect to signals received by the first connector and/or signals provided to the accessory.

2. The connector system of claim 1, further comprising the second connector and an RFID tag identifying at least one characteristic of said second connector.

3. The connector system of claim 2, wherein said RFID reader receives information identifying at least one characteristic of the second connector from said RFID tag of said second connector.

4. The connector system of claim 1, wherein the connection paths are electrical connection paths adapted to transmit electrical signals and/or to provide for electrical power connection.

5. The connector system of claim 1, wherein the connection paths are optical adapted to transmit optical signals.

6. The connector system of claim 1, wherein said RFID reader receives information identifying at least one characteristic of the second connector from an RFID tag of such second connector.

7. The connector system of claim 1, wherein the electronic device comprises portable electronic equipment, said first connector comprises a connector adapted to connect respective second connectors of accessories for use with said portable electronic equipment.

8. (canceled)

9. (canceled)

10. The connector system of claim 1, wherein said operating circuitry is adapted to assume a default setting if said RFID reader has not received information identifying at least one characteristic of such second connector.

11. The connector system of claim 7, wherein said portable electronic equipment comprises a mobile telephone.

12. The connector of claim 2, wherein said RFID tag is a passive transponder adapted to provide a response to said RFID reader.

13. The connector of claim 2, wherein said RFID tag is an active transponder responsive to input from said RFID reader.

14. The connector system of claim 1, wherein said RFID reader is a near field communication device adapted to cooperate in RFID relation with an RFID transponder in near field relation to said RFID reader.

15. A method of identifying an accessory to electronic equipment comprising:
using RFID communication between such accessory and such electronic equipment to identify such accessory to such electronic equipment; and
based on identification of the accessory, adjusting settings in operating circuitry of the electronic equipment, the settings determining functioning of the operating circuitry with respect to signals received from and/or provided to such accessory.

16. The method of claim 15, said using RFID communication comprising using near field communication between an RFID reader and an RFID transponder.

17. (canceled)

18. The method of claim 15, wherein said adjusting settings comprises establishing or maintaining a default setting in the absence of a recognizable or recognized RFID response from an RFID transponder.

19. Portable electronic equipment, comprising:
operating circuitry,
a display,
an input apparatus,
a connector adapted for connection to an accessory, and
an RFID reader adapted to receive information identifying at least one characteristic of an accessory and/or of an accessory connector,
wherein said operating circuitry is adapted to adjust settings for the portable electronic equipment in response to such identification or lack of such identification, and wherein the settings determine functioning of the operating circuitry with respect to signals received by the connector and/or signals provided to the accessory.

20. The portable electronic equipment of claim 19, comprising a mobile telephone, and said input apparatus comprises a keypad.

21. The portable electronic equipment of claim 19, further comprising an accessory including an accessory connector connectible with said connector, and an RFID tag cooperable with said RFID reader to provide such identifying information.

22. The portable electronic equipment of claim 21, wherein said RFID tag is an active transponder responsive to input from said RFID reader.

23. The portable electronic equipment of claim 21, wherein said RFID tag is a passive transponder adapted to provide a response to said RFID reader.

24. The portable electronic equipment of claim 19, wherein said RFID reader is a near field communication device adapted to cooperate in RFID relation with an RFID transponder in near field relation to said RFID reader.

25. The portable electronic equipment of claim 19, wherein said operating circuitry is adapted to assume a default setting in the absence of a recognizable or recognized RFID response from an RFID tag.

26. The portable electronic equipment of claim 19, wherein the RFID reader receives such identifying information from an RFID tag associated with the accessory.

27. The portable electronic equipment of claim 19, wherein the settings adjusted by the operating circuitry relate to at least one of pin-outs, amplification, equalization, or bandwidth.

28. The connector system of claim 1, wherein the settings adjusted by the operating circuitry relate to at least one of pin-outs, amplification, equalization, or bandwidth.
